(19) United States
(12) Patent Application Publication
(10) Pub. No.: US 2022/0154937 A1
(43) Pub. Date: May 19, 2022

(54) LIGHTING SYSTEM AND METHOD FOR DISPLAYING A CONTROL SETTING OF A COOKING APPLIANCE

(71) Applicant: COPRECI, S.COOP., Aretxabaleta (ES)

(72) Inventors: Félix QUEREJETA ANDUEZA, Hendaye (FR); Aitor ZABALO BAYON, ARRASATE-MONDRAGON (ES); José Ignacio MÚGICA ODRIOZOLA, BERGARA (ES)

(21) Appl. No.: 17/171,654

(22) Filed: Feb. 9, 2021

(30) Foreign Application Priority Data
Nov. 13, 2020 (EP) 20382979.1

(51) Int. Cl. F24C 3/12; F21V 33/00; H05B 47/105

(52) U.S. Cl. CPC F24C 3/12; F21V 23/0492; H05B 47/105; F21V 33/0044

(57) ABSTRACT

Apparatus and method of indicating a control setting of a gas cooking appliance. The gas cooking appliance includes a burner, a flame detector for detecting a flame of the burner, a gas valve that controls gas flow to the burner, a control knob coupled to the gas valve and rotatable to control the gas flow to the burner and a lighting system for emitting different light signals depending on the position of the control knob. The control knob is movable between a closed position where no gas is allowed to pass to the burner and an open position where gas is allowed to pass to the burner, the open position comprising a plurality of operable positions, wherein each operable position is related to a quantity of gas passing to the burner. The lighting system includes a power control assembly cooperating with the control knob and electrically coupled to a lighting device. The power control assembly is also connected to the flame detector so that the lighting device only switches on, according to the gas quantity passing to the burner, only if the flame detector detects a flame.

### CROSS-REFERENCE TO RELATED APPLICATIONS

This application relates to and claims the benefit and priority to European Application No. EP20382979.1, filed Nov. 13, 2020.

### TECHNICAL FIELD

The present invention relates to gas cooking appliances and to a method of indicating a control setting of said gas cooking appliances.

### BACKGROUND

Gas cooking appliances, such as barbecues, having a frontal panel where there are a plurality of control knobs to regulate the gas passing to the corresponding burner are known. Turning a control knob, usually counterclockwise, the quantity of gas passing towards the corresponding burner is regulated. Regulation is usually from maximum quantity of gas to the minimum, i.e. from the maximum power to the minimum power. In this way, an enough quantity of gas is assured to ignite the corresponding burner. The ignition of the burner usually takes place near the maximum power location.

In this sense, US20060203462A1 discloses an outdoor grill having a lighting system for indicating the control setting of it. Portions of the frontal panel and control knob are able to be illuminated. The control knob is operable to change control of the barbecue and has a control knob indicator silkscreen printed on it while a temperature settings or power settings are also silkscreen printed adjacently to the control knob. Those silkscreen printed elements are made of translucent material so that when LEDs disposed below said elements are lit a light of ray can reach this elements to illuminate them. When the control knob is turned to control the setting of the corresponding burner, the indicator silkscreen printed on the control knob also rotates, so that said indicator points within the range of the temperature setting. In another embodiment, the temperature settings are silkscreen printed on the control knob and turn with it while the indicator (or pointer) is silkscreen printed in the frontal panel adjacent to the control knob. Therefore, when the control knob is turned the temperature settings are arranged in such a way that the indicator is pointing within the range of the temperature setting.

### SUMMARY

Disclosed is a gas cooking appliance and a method of indicating a control setting of the gas cooking appliance.

The gas cooking appliance of the invention comprises at least one burner, a respective flame detector for detecting the flame of the burner, a respective control knob for controlling the gas flow to the burner and a respective lighting system for emitting different light signals depending on the position of the control knob.

The control knob is movable between a closed position where no gas is allowed to pass to the burner and an open position where gas is allowed to pass to the burner, the open position comprising a plurality of operable positions, wherein each operable position is related to a quantity of gas passing to the burner.

The lighting system comprises a power control assembly cooperating with the control knob, and a lighting device connected to the power control assembly.

The power control assembly is also connected to the flame detector so that the lighting device only switches on, according to the gas quantity passing to the burner, only if the flame detector detects flame.

According to one embodiment, the method of indicating the control setting of the gas cooking appliance comprises the steps described below. When a user turns the control knob of a corresponding burner to the open position, a respective sparker (spark generator) of an ignitor of the gas cooking appliance, which also comprises the flame detector, automatically ignites the burner, and thus the associated flame detector detects flame in said burner as long as there is flame. The user can continue turning the control knob until the desired power is achieved in the burner. The lighting device of the lighting system switches on according to the gas quantity passing to the burner only as long as the flame detector is detecting flame in the corresponding burner.

Illuminating the frontal panel of the gas cooking appliance allows the user to easily identify, even if he is far away from the gas cooking appliance, if the gas cooking appliance is on, even in reduced visibility conditions such as at night. Indeed, switching on the lighting device according to the gas quantity passing to the corresponding burner allows the user to easily identify the power of each burner. This can help the user to control the status of the barbecue while he enjoys, for example, family or friends since it is not necessary to be at the gas cooking appliance continuously to control it.

Further, thanks to the lighting system, the user can be sure that if a lighting device is on there is flame in the corresponding burner. If the lighting device is off, when it should be on, means that the flame has switched off unintentionally, for example due to a gust of wind. The user then can react immediately to avoid a leak of gas.

These and other advantages and features will become evident in view of the drawings and detailed description.

### BRIEF DESCRIPTION OF THE DRAWINGS

FIG. 1 shows a perspective view of a gas cooking appliance according to an embodiment.

FIG. 2 shows a schematic view of the burners of the gas cooking appliance of FIG. 1.

FIG. 3 shows a perspective view the power control assembly joined to a gas valve of the gas cooking appliance of FIG. 1.

FIG. 4 shows a side view of the power control assembly joined to the gas valve of FIG. 3 to which the respective control knob has been attached.

FIG. 5 shows an exploded view of the power control assembly of the gas cooking appliance of FIG. 1.

FIG. 6A shows a first perspective view of a front side of the power control assembly of the lighting system of the gas cooking appliance of FIG. 1.

FIG. 6B shows a second perspective view of a rear side of the power control assembly of the lighting system of the gas cooking appliance of FIG. 1.

FIG. 7 shows an embodiment of a printed circuit board mounted in a rear cap of the power control assembly of the lighting system of the gas cooking appliance of FIG. 1.

FIG. 8 shows the rotary connector mounted in a front cap of the power control assembly of the lighting system of the gas cooking appliance of FIG. 1.

FIG. 9A shows a front view of the rotary connector of the power control assembly of the lighting system of the gas cooking appliance of FIG. 1.

FIG. 9B shows a perspective view of the rotary connector of a rear side of the power control assembly of the lighting system of the gas cooking appliance of FIG. 1.

FIG. 10 shows a front view of the printed circuit board of FIG. 7 and the electric circuit formed therein.

FIG. 11 shows a front view of another embodiment of a printed circuit board mounted in the rear cap of the power control assembly of the lighting system of the gas cooking appliance and the electric circuit formed therein.

FIG. 12A shows a front view of an embodiment of the control knob and the respective lighting device of the gas cooking appliance of FIG. 1 with the control knob in the closed position.

FIG. 12B shows a front view of the control knob of FIG. 12A positioned in one operable position and the respective lighting device switched on accordingly.

FIG. 12C shows a front view of the control knob of FIG. 12A positioned in another operable position and the respective lighting device switched on accordingly.

FIG. 12D shows a front view of the control knob of FIG. 12A positioned in another operable position and the respective lighting device switched on accordingly.

FIG. 13A shows a front view of another embodiment of the control knob and the respective lighting device of the gas cooking appliance of the invention with the control knob in the closed position.

FIG. 13B shows a front view of the control knob of FIG. 13A positioned in the ignition position and the respective lighting device switched on accordingly.

FIG. 13C shows a front view of the control knob of FIG. 13A positioned in one operable position and the respective lighting device switched on accordingly.

FIG. 13D shows a front view of the control knob of FIG. 13A positioned in another operable position and the respective lighting device switched on accordingly.

FIG. 13E shows a front view of the control knob of FIG. 13A positioned in another operable position and the respective lighting device switched on accordingly.

FIG. 14A shows the rotary connector mounted on the printed circuit board of FIG. 7, the relative position between them corresponding to the position of the control knob of FIG. 12A.

FIG. 14B shows the rotary connector mounted on the printed circuit board of FIG. 7, the relative position between them corresponding to the position of the control knob of FIG. 12B.

FIG. 14C shows the rotary connector mounted on the printed circuit board of FIG. 7 which is mounted in the rear cup of the power control assembly, the relative position between the rotary connector and the printed circuit board corresponding to another operable position of the control knob of the gas cooking appliance of the invention.

FIG. 14D shows the rotary connector mounted on the printed circuit board of FIG. 7 which is mounted in the rear cup of the power control assembly, the relative position between the rotary connector and the printed circuit board corresponding to the position of the control knob of FIG. 12C.

FIG. 14E shows the rotary connector mounted on the printed circuit board of FIG. 7 which is mounted in the rear cup of the power control assembly, the relative position between the rotary connector and the printed circuit board corresponding to another operable position of the control knob of the gas cooking appliance of the invention.

FIG. 14F shows the rotary connector mounted on the printed circuit board of FIG. 7 which is mounted in the rear cup of the power control assembly, the relative position between the rotary connector and the printed circuit board corresponding to the position of the control knob of FIG. 12D.

### DETAILED DESCRIPTION

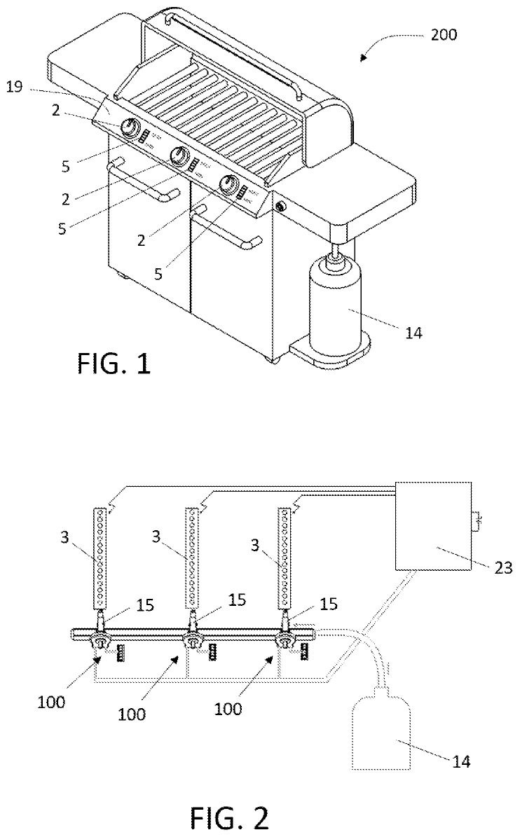

FIG. 1 shows an embodiment of a gas cooking appliance 200 of the invention, which in this specific embodiment is a barbecue. The barbecue 200 comprises a frontal panel 19 where a plurality of control knobs 2 are disposed, three control knobs 2 in the embodiment of FIG. 1. The control knobs 2 are used to change control of the barbecue 200. Each control knob 2 controls the gas flow to a respective burner 3 through a respective gas valve 15, as can be seen in FIG. 2. The burner 3 is arranged downstream of the gas valve 15.

The barbecue 200 of FIG. 1 is a kind of outdoor grill and thus it comprises a portable gas supply 14. The scope of the invention would also be valid if the gas cooking appliance 200 is connected to a fixed gas supply.

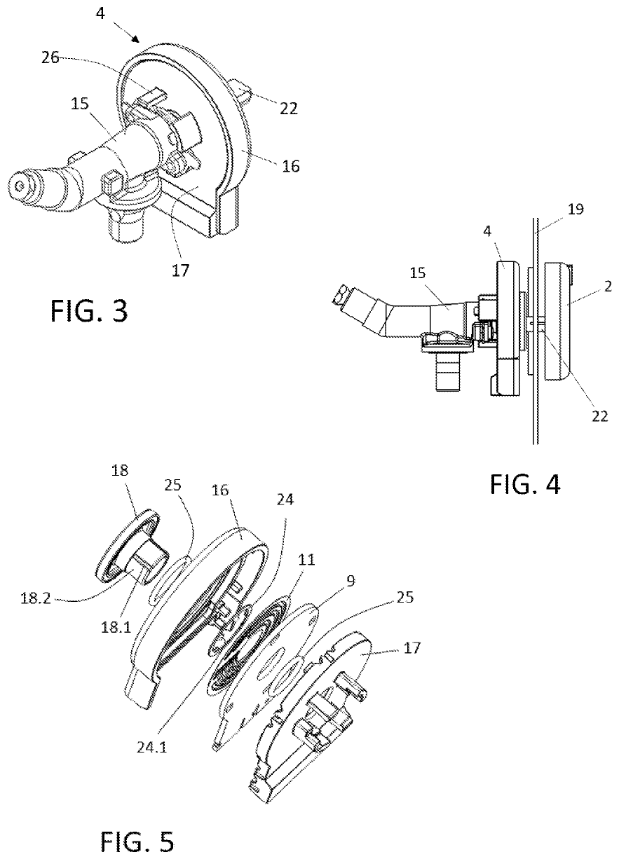

The gas supplied by the gas supply 14 is distributed towards the burners 3 through a respective gas valve 15. The gas valve 15 is manually driven using an actuator 22 which is mechanically coupled to the gas valve 15 by one of its ends and to the control knob 2 by the other end, as can be seen for example in FIGS. 3 and 4.

The control knob 2, cooperating with a corresponding burner 3 of the barbecue 200, is movable between a closed position where no gas is allowed to pass to the corresponding burner 3 and an open position where gas is allowed to pass to the burner 3, the open position comprising a plurality of operable positions wherein each operable position 2.1 is related to a quantity of gas passing to the burner 3.

One possible operable position would be the one corresponding to the maximum power PMAX of the burner 3 where the maximum quantity of gas is allowed to pass to the corresponding burner 3. Another possible operable position would be the one corresponding to the minimum power PMIN of the burner 3 where the minimum quantity of gas is allowed to pass to the corresponding burner 3. Other possible operable positions would be intermediate positions.

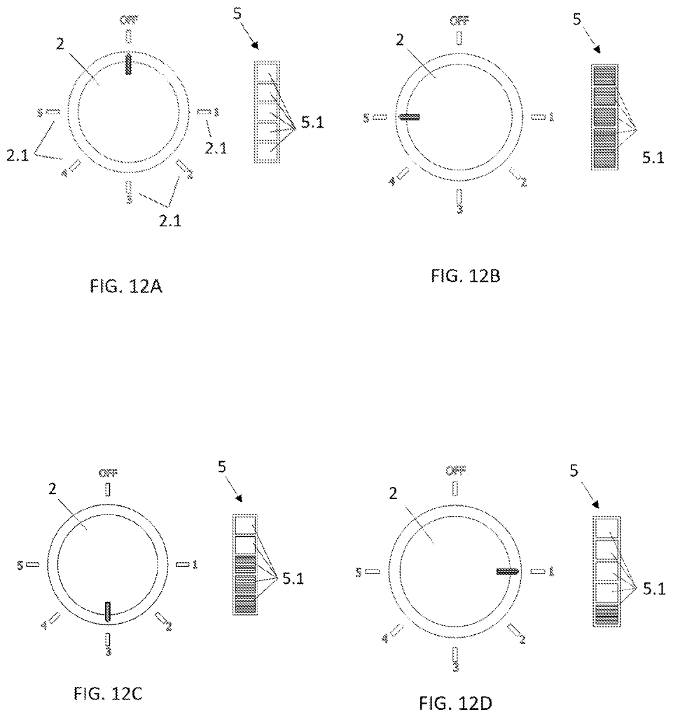

According to one embodiment, the control knob 2 of the barbecue 200 comprises five different operable positions 2.1, as can be seen in FIGS. 12A to 12D. The operable position PMAX correspond to the one referenced in FIGS. 12A to 12D as number 5 and the PMIN to the one referenced as number 1. The quantity of gas passing to the corresponding burner 3 decreases as the referenced number of the operable position 2.1 of the control knob 2 decreases.

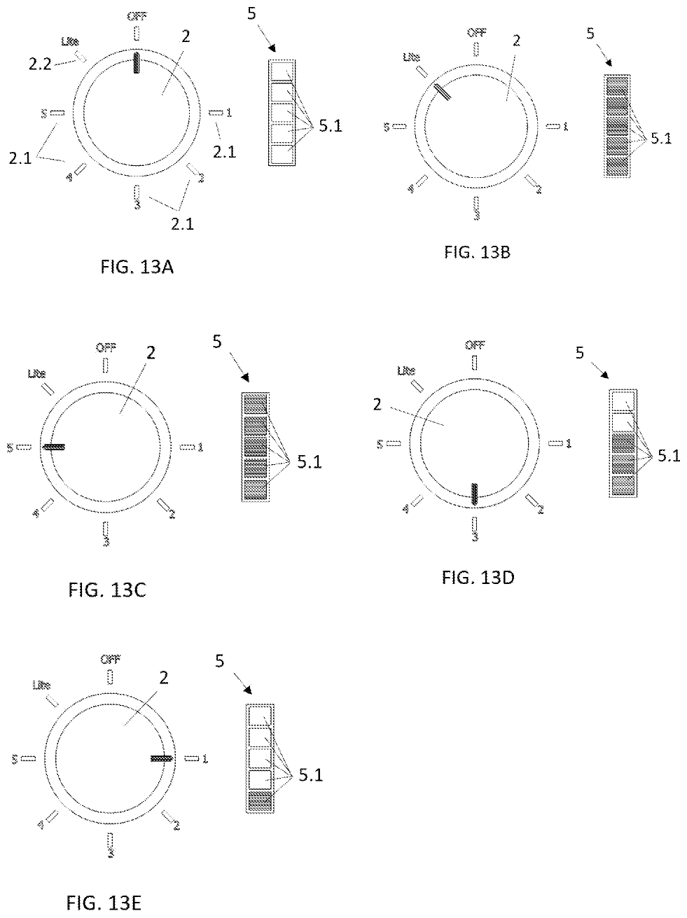

According to another embodiment of the invention, the open position of the control knob 2 of the barbecue 200 further comprises an ignition position 2.2 for igniting the burner 3, the control knob 2 therefore comprises five different operable positions 2.1 and an ignition position 2.2, as can be seen in FIGS. 13A to 13E. The ignition position 2.2, referenced as “Lite” in the drawings, is located between the closed position, referenced as OFF in the drawings, and the PMAX operable position, referenced as 5 in the drawings. As in the example of FIGS. 12A to 12D, the operable position PMAX correspond to the one referenced in FIGS. 13A to 13E as number 5 and the PMIN to the one referenced as number 1. The quantity of gas passing to the corresponding burner 3 decreases also as the referenced number of the operable position 2.1 of the control knob 2 decreases. As said, the ignition position 2.2 is a specific position where the ignition of the corresponding burner 3 takes place. In the embodiment of FIGS. 12A to 12D the ignition of the corresponding burner 3 may take place in any of the different operable positions 2.1 as it would be explained later on.

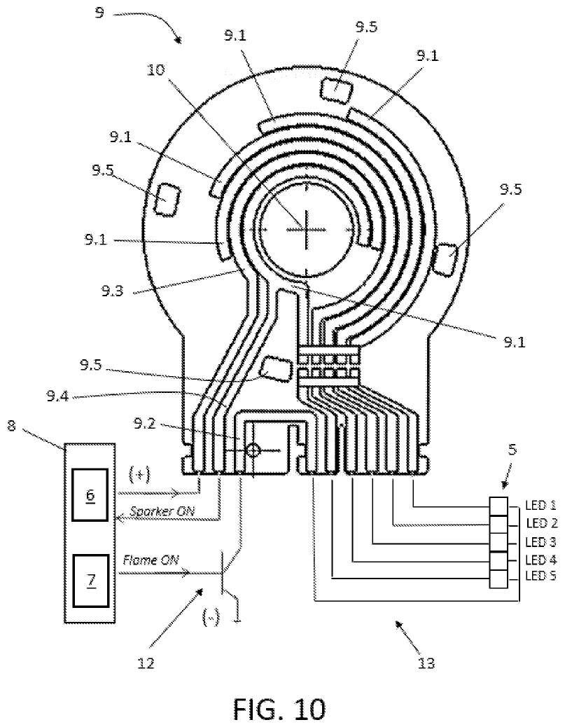

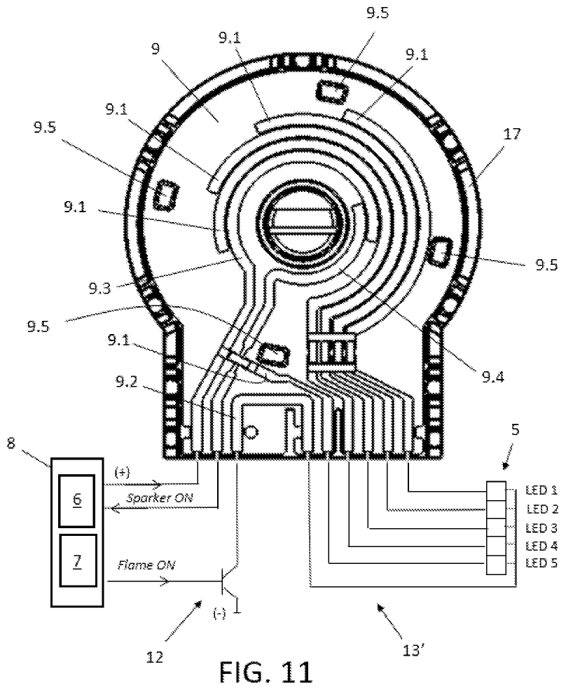

The barbecue 200 comprises an ignitor 8, shown schematically in FIGS. 10 and 11, which cooperates with the burners 3. The ignitor 8 comprises a sparker 7 (spark generator) and a flame detector 6 for a respective burner 3. When the gas passes to the burner 3 the corresponding sparker 7 ignites the burner 3 and the respective flame detector 6 will detect the flame generated therein as long as the flame is lit.

The gas cooking appliance 200 of the invention further comprises a lighting system 100 for emitting different light signals depending on the position of each of the control knobs 2. The lighting system 100 is connected to the ignitor 8 and cooperates with each of the burners 3 of the gas cooking appliance 200 and comprises a respective power control assembly 4, which cooperates with a corresponding control knob 2, and a respective lighting device 5 which is connected to a corresponding power control assembly 4.

The power control assembly 4 is also connected to the flame detector 6 of the barbecue 200 associated to a respective burner 3 therefore, the corresponding lighting device 5 will switch on according to the gas quantity passing to the burner 3 only if the flame detector 6 detects flame.

To achieve this, the method of indicating the control setting of the gas cooking appliance 200, for example a barbecue, may comprise the following steps:
a) a user turning the control knob 2 of a corresponding burner 3 to the open position to allow the pass of the gas towards the burner 3,
b) igniting the respective burner 3: when there is enough gas in the burner 3 the corresponding sparker 7 automatically ignites the respective burner 3,
c) detecting flame: the corresponding flame detector 6 detects flame in the respective burner 3 as long as the flame is on,
d) the user turning the control knob 2 until the desired power in the corresponding burner 3 is achieved, and
e) illuminating the corresponding lighting device 5: the corresponding lighting device 5 switches on according to a gas quantity passing to the corresponding burner 3 only as long as the flame detector 6 is detecting flame.

Steps d) and e) will be repeated as many times as the user wants to change the power of the corresponding burner 3.

Illuminating the frontal panel 19 of the gas cooking appliance 200, a barbecue according to the example of FIG. 1, allows the user to easily identify, even if he is far away from the barbecue 200, if the barbecue 200 is on, even in reduced visibility conditions such as at night. Indeed, switching the corresponding lighting device 5 on according to the gas quantity passing to the respective burner 3 allows the user to easily identify the power to which each of the burners 3 of the barbecue 200 is currently set. This can help the user to control the status of the barbecue 200 while he enjoys, for example, family or friends since it is not necessary to be at the barbecue 200 continuously to control it.

Further, thanks to the lighting system 100 of the invention, the user can be sure that if a corresponding lighting device 5 is lighting there is flame in the corresponding burner 3. If the lighting device 5 is off, when it should be on, means that the flame has switched off unintentionally, for example due to a gust of wind. The user then can react immediately to avoid a leak of gas.

Since barbecues are usually used outside, for example in a garden, where the visibility is reduced, especially at night, the lighting system 100 of the invention is especially advantageous in such cases.

As shown in FIG. 2, the barbecue 200 of FIG. 1 comprises three burners 3, gas to all of them being supplied from the portable gas supply 14 through the respective gas valve 15 and being controlled by a control unit 23. Each of the gas valve 15 is coupled to a respective power control assembly 4 as can be seen in detail in FIGS. 3 and 4.

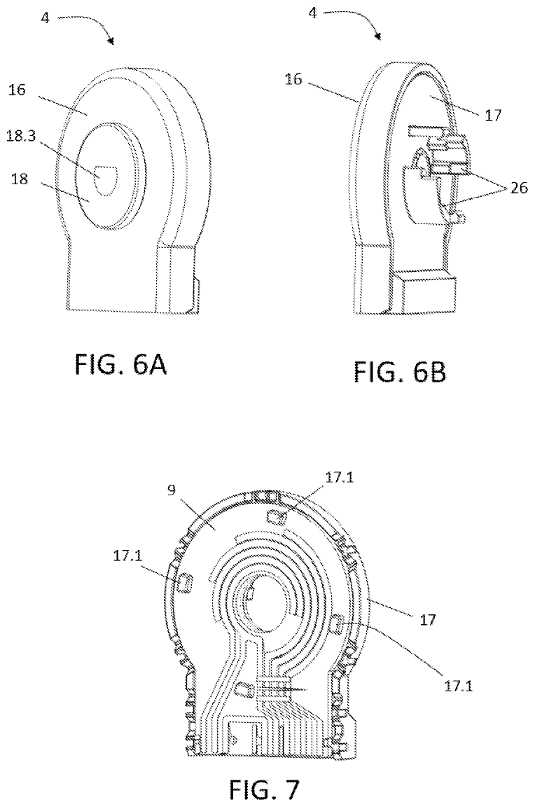

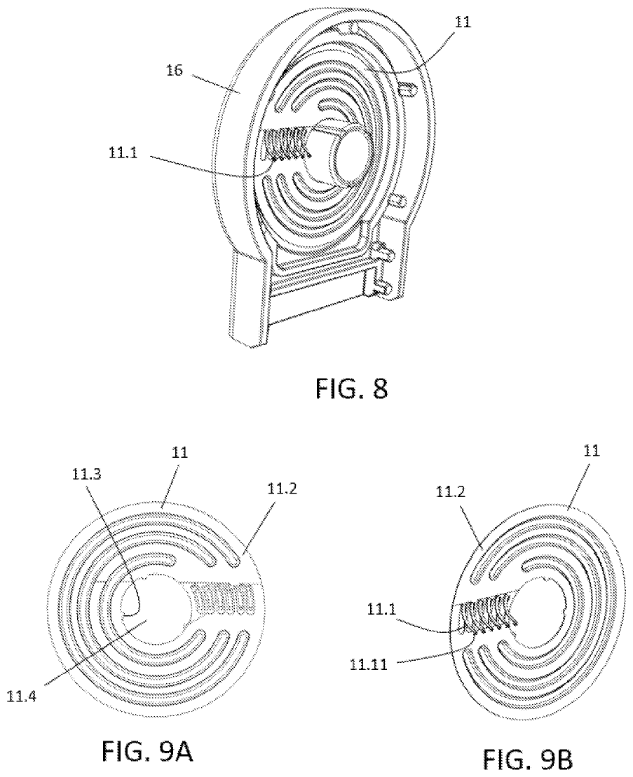

The power control assembly 4 comprises a front cap 16 and a rear cap 17, as can be seen in FIGS. 6A and 6B, which are detachable joined. The power control assembly 4 further comprises a printed circuit board 9 and a rotary connector 11. FIG. 5 shows an exploded view of the power control assembly 4 of the gas cooking appliance 200 of the invention. The printed circuit board 9 is mounted on the rear cap 17, as can be seen for example in FIG. 7. The rotary connector 11, which rotates in unison with the corresponding control knob 2 to which it is connected, is mounted on the front cap 16, as can be seen in FIG. 8.

The rear cap 17 comprises a plurality of fixing protrusions 17.1 directed towards the inside of the power control assembly 4. The printed circuit board 9 comprises a plurality of fixing recesses 9.5 so that a fixing protrusion 17.1 of the rear cap 17 is housed in a respective fixing recess 9.5 of the printed circuit board 9, the printed circuit board 9 being thus fixed inside the power control assembly 4.

The rear cap 17 of the power control assembly 4 further comprises a mounting protrusions 26 which protrude from the outside of the rear cup 17 and which allow to fixed the power control assembly 4 to the corresponding gas valve 15, as can be seen in FIG. 3.

A sleeve 18 is also mounted on the front cap 16 of the power control assembly 4 having a cylindrical protrusion 18.2 directed towards the inside of the power control assembly 4 and which is axially fixed against the frontal cap 16 by a circular ring 24 having an elastic radially protruding tabs 24.1. The actuator 22 passes through the power control assembly 4 to be able to be assembled to the gas valve 15 and to the control knob 2 in each of its ends respectively. The actuator 22 is housed and fixed in a recess 18.3 of the sleeve 18 having a cut circular shape so that when the user turns the control knob 2 the sleeve 18 also rotates in unison acted by the actuator 22.

The rotary connector 11 comprises a circular flat base 11.2, as can be seen in FIGS. 9A and 9B, and comprises a central hole 11.4 which allows to be mounted on the cylindrical protrusion 18.2 of the sleeve 18. Said central hole 11.4 comprises a plurality of radially protruding ledges 11.3 which are housed in respective recesses 18.1 disposed in the cylindrical protrusion 18.2 of the sleeve 18, so that when the sleeve 18 rotates actuated by the actuator 22 the rotary connector 11 also rotates.

In order to avoid that any liquid can penetrate the power control assembly 4, the latter one comprises a plurality of sealing members 25 such a O-rings. As can be seen in FIG. 5, one O-ring is disposed between the sleeve 18 and the front cap 16 and another one between the printed circuit board 9 and the rear cap 17.

The rotary connector 11 comprises a plurality of protruding tabs 11.1 protruding from the circular base 11.2 and which are connected with each other and which are disposed in parallel, as can be seen in FIG. 9B, each of the protruding tab 11.1 being joined to the circular base 11.2 by its upper side. The free end of each of the protruding tab 11.1 defines a contact end 11.11 which is able to contact with the printed circuit board 9. All of the contact ends 11.11 are disposed in an offset parallel radial direction.

The lighting device 5 comprises a plurality of LEDs 5.1, the number of lit LEDs 5.1 being indicative of the quantity of gas passing to the corresponding burner 3.

The printed circuit board 9 comprises a plurality of tracks 9.1, 9.2, 9.3 and 9.4, some of said tracks 9.1, 9.2, 9.3 and 9.4 being connected to the corresponding lighting device 5. The rotary connector 11 and the printed circuit board 9 are faced to each other in such a way that the protruding tabs 11.1 of the rotary connector 11 contact with one or more tracks 9.1, 9.2, 9.3 and 9.4 of the printed circuit board 9 depending on the angular position of the rotary connector 11.

The lighting system 100 of the invention is connected to the ignitor 8 that is powered by a power source, such as a battery.

The lighting system 100 also comprises a switch 12 which allows to connect the lighting system 100 to ground if the flame detector 6 detects flame in the corresponding burner 3, i.e. as long as there is flame in the corresponding burner 3 the electrical circuit 13 or 13′ formed therein will remain closed.

According to an embodiment, the switch 12 is a transistor, the base of the transistor being connected to the corresponding flame detector 6, the collector of the transistor being connected to the power control assembly 4 and the emitter of the transistor being connected to ground.

The printed circuit board 9 according to a first embodiment comprises a flame track 9.2 connected to the corresponding flame detector 6 through the switch 12, a power track 9.3 connected to the ignitor 8, a sparker track 9.4 connected to the corresponding sparker 7 of the ignitor 8 and a plurality of main tracks 9.1 connected to said flame track 9.2. Each LED 5.1 of the corresponding lighting device 5 is connected to a different main track 9.1, as shown in FIG. 10, so that depending on the angular position of the control knob 2 a corresponding LED 5.1 of the lighting device 5 is lit if the associated main track 9.1 is contacting with the respective protruding tab 11.1 of the rotary connector 11 and if the flame of the corresponding burner 3 is on.

According to this embodiment, one protruding tab 11.1 of the rotary connector 11 is contacting with the power track 9.3 of the printed circuit board 9 independently of the angular position of the control knob 2. The rest of the protruding tabs 11.1 contacts with one or more main tracks 9.1 and with the sparker track 9.4 of the printed circuit board 9.

In this embodiment, one of the main tracks 9.1 is joined to the sparker track 9.4, which allows to save space in the printed circuit board 9. Another protruding tab 11.1 of the rotary connector 11 is contacting the sparker track 9.4 independently of the angular position of the control knob 2, and therefore also contacts the main track 9.1 joined to the sparker track 9.4. Therefore, in this embodiment if the flame of a burner 3 is extinguished unintentionally, for example due to a gust of wind, the corresponding sparker 7 will try to ignite the corresponding burner 3 again independently of the angular position of the control knob 2 since the power control assembly 4 is constantly sending an electrical signal to the sparker 7 of the ignitor 8. Said electrical signal is interpreted by the control unit 23 of the gas cooking appliance 200 as an order to activate the corresponding sparker 7. Therefore, the ignitor 8 is able to ignite the burner 3 in any of the operable positions 2.1 of the control knob 2.

As can be seen in FIG. 10, the main tracks 9.1 finishes in a different angular positions related to a rotation axis 10 of the control knob 2, so that when a main track 9.1 is not contacted by a protruding tab 11.1 of the rotary connector 11 the LED 5.1 associated to this main track 9.1 is not lit.

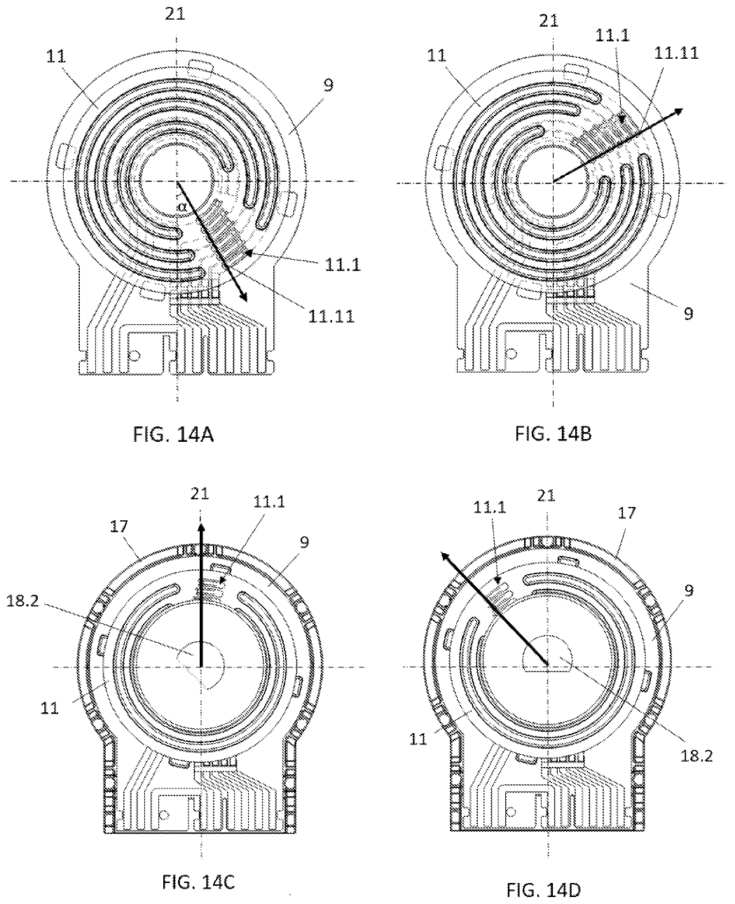

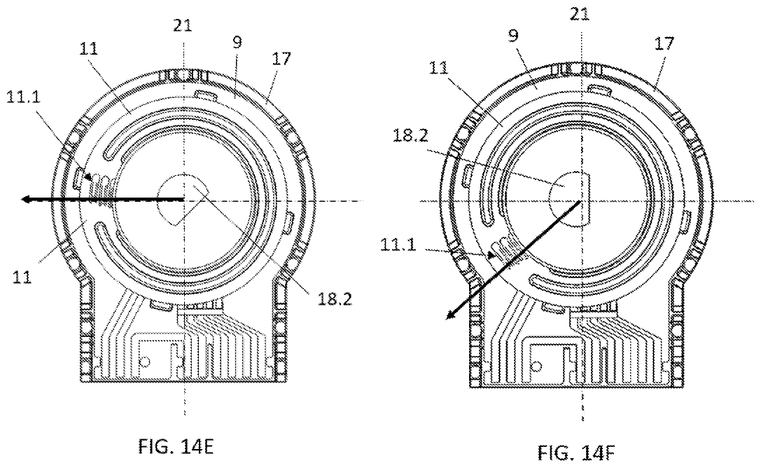

Being the control knob 2 in the closed position, as shown for example in FIG. 12A, the relative position between the rotary connector 11 and the printed circuit board 9, according to any of the described embodiments, is such that the contact ends 11.11 of the protruding tabs 11.1 of the rotary connector 11 are advanced an angle α with respect to the vertical axis 21 passing through the center of the rotation axis 10, as can be seen in FIG. 14A. Said angle α is within a range of 0° and 60°, preferably within 10° and 50° and said angle α being preferably 30°.

FIGS. 12A to 12D show the different angular positions of the control knob 2 according to a first embodiment and the status of the respective lighting device 5. Said control knob 2 comprises five different operable positions 2.1.

In FIG. 12A the control knob 2, according to said first embodiment, is in the closed position, represented in the drawings as OFF, i.e. rotated 0° with respect to the vertical axis 21. In this angular position no gas is allowed to pass to the corresponding burner 3 and therefore, all the LEDs 5.1 of the respective lighting device 5 are switched off since there is no flame in the burner 3.

In FIG. 12B the control knob 2 is rotated 90° counter clockwise with respect to the vertical axis 21, the relative position between the rotary connector 11 and the printed circuit board 9, according to any of the described embodiments, being the one illustrated in FIG. 14B. In FIG. 12B the control knob 2 is positioned in an operable position 2.1 where the gas quantity passing to the corresponding burner 3 is maximum, so that all LEDs 5.1 of the respective lighting device 5 will be lit as long as the flame of the burner 3 is on. Said operable position 2.1 corresponds to the PMAX position and it is referenced as number 5. In this operable position 2.1, one protruding tab 11.1 of the rotary connector 11 is contacting the power track 9.3 of the printed circuit board 9, another protruding tab 11.1 is contacting the sparker track 9.4 (spark generator track), and since the sparker track 9.4 is joined to one of the main track 9.1 also contacts said main track 9.4, and the rest of the protruding tabs 11.1 are contacting a respective main track 9.1, therefore, all of the protruding tabs 11.1 of the rotary connector 11 are contacting a respective track of the printed circuit board 9.

Passing the control knob 2 from the closed position to said PMAX position means that the burner 3 was previously off and thus when passing to the open position the burner 3 must be ignited. Since the PMAX position is the first operable position 2.1 when turning the control knob 2 counter clockwise, the sparker 7 will ignite the burner 3 in this operable position 2.1.

In FIG. 12D the control knob 2 is rotated 270° counter clockwise with respect to the vertical axis 21, the relative position between the rotary connector 11 and the printed circuit board 9, according to any of the described embodiments, being the one illustrated in FIG. 14F. In FIG. 12D the control knob 2 is positioned in an operable position 2.1 where the gas quantity passing to the corresponding burner 3 is minimum. said operable position 2.1 corresponding to the PMIN position and it is referenced as number 1. In this operable position 2.1, one protruding tab 11.1 of the rotary connector 11 is contacting the power track 9.3 of the printed circuit board 9, another protruding tab 11.1 is contacting the sparker track 9.4, and since the sparker track 9.4 is joined to one of the main track 9.1 also contacts said main track 9.4, and none of the rest of the protruding tabs 11.1 are contacting with a respective main track 9.1, therefore, only one main track 9.1 is contacted by a respective protruding tab 11.1 so that only one LED 5.1 of the respective lighting device 5 will be lit as long as the flame of the burner 3 is on.

Being the control knob 2 in this PMIN operable position 2.1 if the flame of the burner 3 is unintentionally extinguished, for example due to a gust of wind, the corresponding sparker 7 will ignite the corresponding burner 3 in this operable position 2.1. Therefore, the risk of a leak of gas is drastically reduced.

The lighting device 5 of the invention comprises as many LEDs 5.1 as the number of defined operable positions 2.1, five LEDs in the embodiment of FIGS. 12A to 12D. When the control knob 2 is in an operable position 2.1 arranged between 90° and 270° counter clockwise with respect to the vertical axis 21, the number of lit LEDs 5.1 will decrease as the control knob 2 rotates counter clockwise towards the next defined operable position 2.1.

In this sense, FIG. 12C shows a control knob 2 positioned in a medium operable position 2.1, referenced as number 3, the relative position between the rotary connector 11 and the printed circuit board 9, according to any of the described embodiments, being the one illustrated in FIG. 14D. In this operable position 2.1 three of the main tracks 9.1 of the printed circuit board 9 are contacting with a respective protruding tab 11.1 of the rotary connector 11 and therefore, only three LEDs 5.1 of the corresponding lighting device 5 will be lit as long as the flame of the burner 3 is on, the rest LEDs 5.1 remaining off.

The relative position between the rotary connector 11 and the printed circuit board 9 shown in FIG. 14C, according to any of the described embodiments, is related to an operable position 2.1 where the control knob 2 is rotated 135° with respect to the vertical axis 21.

The relative position between the rotary connector 11 and the printed circuit board 9 shown in FIG. 14E, according to any of the described embodiments, is related to an operable position 2.1 where the control knob 2 is rotated 225° with respect to the vertical axis 21.

According to this embodiment, being the control knob 2 in any of the operable positions 2.1 if the flame of the burner 3 is unintentionally extinguished, for example due to a gust of wind, the corresponding sparker 7 will ignite the corresponding burner 3 in the current operable position 2.1 of the control knob 2. Therefore, the risk of a leak of gas is drastically reduced.

The printed circuit board 9 according to a second embodiment of the invention comprises a flame track 9.2 connected to the corresponding flame detector 6 through the switch 12, a power track 9.3 connected to the ignitor 8, a sparker track 9.4 connected to the corresponding sparker 7 of the ignitor 8 and a plurality of main tracks 9.1 connected to said flame track 9.2. Each LED 5.1 of the corresponding lighting device 5 is connected to a different main track 9.1, as shown in FIG. 11, so that depending on the angular position of the control knob 2 a corresponding LED 5.1 of the lighting device 5 is lit if the associated main track 9.1 is contacting with the respective protruding tab 11.1 of the rotary connector 11 and if the flame of the corresponding burner 3 is on.

According to this second embodiment, one protruding tab 11.1 of the rotary connector 11 is contacting with the power track 9.3 of the printed circuit board 9 independently of the angular position of the control knob 2. The rest of the protruding tabs 11.1 contacts with one or more main tracks 9.1 of the printed circuit board 9.

However, depending on the angular position of the control knob 2 a protruding tab 11.1 of the rotary connector 11 will contact the sparker track 9.4 or not.

In this second embodiment, one of the main tracks 9.1 is in electrical contact to the power track 9.3, so that a protruding tab 11.1 of the rotary connector 11 contacts with the power track 9.3, and therefore with at least one of the main tracks 9.1, independently of the angular position of the control knob 2. Another protruding tab 11.1 of the rotary connector 11 will contact the sparker track 9.4 only in a specific angular position of the control knob 2. The rest of the main tracks 9.1 will contact a respective protruding tab 11.1 of the rotary connector 11 depending on the angular position of the control knob 2. Therefore, in this embodiment if the flame of a burner 3 is unintentionally extinguished, for example due to a gust of wind, the corresponding sparker 7 will ignite the corresponding burner 3 only in the angular position of the control knob 2 where contacts with the sparker track 9.4, i.e. the user must turn the control knob 2 to the ignition position 2.2 where this is allow to happen.

As can be seen in FIG. 11, the main tracks 9.1 finishes in a different angular positions related to a rotation axis 10 of the control knob 2, so that when a main track 9.1 is not contacted by a protruding tab 11.1 of the rotary connector 11 the LED 5.1 associated to this main track 9.1 is not lit. When the main track 9.1 is joined to the power track 9.3 they are considered one track that finishes in an angular position.

FIGS. 13A to 13E show the different angular positions of the control knob 2 according to the second embodiment and the status of the respective lighting device 5. In this case, the control knob 2 comprises five different operable positions 2.1 and an ignition position 2.2. Comparing with the control knob 2 of the previously described embodiment referring to FIGS. 12A to 12D, this control knob 2 comprises the ignition position 2.2, referenced as “Lite” in the drawings. This ignition position 2.2 is located between the closed position (referenced as OFF in the drawings) and the PMAX position (referenced as 5 in the drawings), i.e. in an angular position located between 0° and 90° counter clockwise, preferably near 45°.

This ignition position 2.2 is a specific position where the ignition of the corresponding burner 3 takes place. Differing from the previously described embodiment of FIGS. 12A to 12D, the protruding tab 11.1 of the rotary connector 11 associated to the sparker track 9.4 of the printed circuit board 9 only contacts said sparker track 9.4 in said angular position of the control knob 2 shown in FIG. 13B, i.e. out of said angular position the protruding tab 11.1 of the rotary connector 11 is not contacting the sparker track 9.4 and therefore there is not an electrical signal ordering the ignitor 8 the activation of the sparker 7 outside this angular position of the control knob 2.

In said ignition position 2.2 shown in FIG. 13B, referred as “Lite”, the gas quantity passing to the corresponding burner 3 is also maximum. The power track 9.3, the sparker track 9.4 and all of the main tracks 9.1 of the printed circuit board 9 according to the embodiment of FIG. 11, are contacted by a respective protruding tab 11.1 of the rotary connector 11 and thus all LEDs 5.1 of the respective lighting device 5 will be lit as long as the flame of the burner 3 is on.

The closed position shown in FIG. 13A is the same as the closed position of the control knob 2 of FIG. 12A and the rest of the operable positions 2.1 of both embodiments of the control knob 2 (related to the power settings represented as 5 to 1 in the drawings) are similar with the exception to the process to be follow in case the flame is extinguished.

According to said second embodiment of the control knob 2, being the control knob 2 is not in the ignition position 2.2, referred as “Lite”, if the flame of the burner 3 is involuntarily extinguished, in order to ignite the burner 3 again, the user must turn the control knob 2 to the ignition position 2.2 referred as “Lite”.

The following clauses disclose additional embodiments.

Clause 1. Gas cooking appliance comprising:
at least one burner (3),
a respective flame detector (6) for detecting the flame of the burner (3),
a respective control knob (2) for controlling the gas flow to the burner (3), the control knob (2) being movable between a closed position where no gas is allowed to pass to the burner (3) and an open position where gas is allowed to pass to the burner (3), the open position comprising a plurality of operable positions (2.1) wherein each operable position (2.1) is related to a quantity of gas passing to the burner (3), and
a respective lighting system (100) for emitting different light signals depending on the position of the control knob (2), the lighting system (2) comprising
   a power control assembly (4) cooperating with the control knob (2), and
   a lighting device (5) connected to the power control assembly (4),
wherein the power control assembly (4) is also connected to the flame detector (6) so that the lighting device (5) only switches on, according to the gas quantity passing to the burner (3), if the flame detector (6) detects flame.

Clause 2. Gas cooking appliance according to clause 1, wherein the lighting system (100) is energized by an ignitor (8) comprising the flame detector (6).

Clause 3. Gas cooking appliance according to clause 2, wherein the lighting system (100) also comprises a switch (12) which allows to connect the lighting system (100) to ground if the flame detector (6) detects flame.

Clause 4. Gas cooking appliance according to clause 3, wherein the switch (12) is a transistor, the base of the transistor being connected to the flame detector (6), the collector of the transistor to the power control assembly (4) and the emitter of the transistor to ground.

Clause 5. Gas cooking appliance according to any of clauses 2 to 4, wherein the lighting device (5) comprises a plurality of LEDs (5.1), the number of lit LEDs (5.1) being indicative of the quantity of gas passing to the burner (3).

Clause 6. Gas cooking appliance according to any of clauses 2 to 5, wherein the power control assembly (4) comprises a printed circuit board (9) comprising a plurality of tracks (9.1, 9.2, 9.3, 9.4), some of said tracks (9.1, 9.2, 9.3, 9.4) being connected to the lighting device (5), the power control assembly (4) further comprising a rotary connector (11) which rotates in solidarity with the control knob (2), the rotary connector (11) comprising a plurality of protruding tabs (11.1) connected with each other and contacting with one or more tracks (9.1, 9.2, 9.3, 9.4) of the printed circuit board (9) depending on the angular position of the rotary connector (11).

Clause 7. Gas cooking appliance according to clause 6, wherein the protruding tabs (11.1) of the rotary connector (11) are protruding from a circular base (11.2) and are disposed in parallel, the free end of each of the protruding tab (11.1) defining a contact ending (11.11) which is able to contact with a track (9.1, 9.2, 9.3, 9.4) of the printed circuit board (9), the contact endings (11.11) of all of the protruding tabs (11.1) being disposed in an offset parallel radial direction, so that in use only the contact endings (11.11) of the rotary connector (11) contacts the printed circuit board (9).

Clause 8. Gas cooking appliance according to clause 6 or 7, wherein the printed circuit board (9) comprises a flame track (9.2) connected to the flame detector (6) through the switch (12), a power track (9.3) connected to the ignitor (8), a sparker track (9.4) connected to a sparker (7) comprised in the ignitor (8) and a plurality of main tracks (9.1) connected to said flame track (9.2), each LED of the lighting device (5) being connected to a different main track (9.1), the electronic circuit (13; 13′) generated therein being closed as long as flame is detected in the burner (3).

Clause 9. Gas cooking appliance according to clause 8, wherein one protruding tab (11.1) contacts with the power track (9.3) and the rest of the protruding tabs (11.1) contacts with one or more main tracks (9.1) and/or with the sparker track (9.4) of the printed circuit board (9) depending on the angular position of the rotary connector (11).

Clause 10. Gas cooking appliance according to clause 8 or 9, wherein at least one of the main tracks (9.1) is joined to the sparker track (9.4) or to the power track (9.3).

Clause 11. Gas cooking appliance according to any of clauses 8 to 10, wherein each of the main track (9.1) finishes in a different angular position related to a rotation axis (10) of the control knob (2), so that when a main track (9.1) is not contacted by a protruding tab (11.1) of the rotary connector (11) the LED (5.1) associated to this main track (9.1) is not lit.

Clause 12. Method of indicating a control setting of a gas cooking appliance (200), the gas cooking appliance (200) comprising
at least one burner (3),
an ignitor (8) comprising a respective sparker (7) for igniting the burner (3) and
a respective flame detector (6) for detecting the flame of the burner (3),
a respective control knob (2) for controlling the gas flow to the burner (3), the control knob (2) being movable between a closed position where no gas is allowed to pass to the burner (3) and an open position where gas is allowed to pass to the burner (3), the open position comprising a plurality of operable positions (2.1) wherein each operable position (2.1) is related to a quantity of gas passing to the burner (3), and
a respective lighting system (100) for emitting different light signals depending on the position of the control knob (2), the lighting system (2) comprising
   a power control assembly (4) cooperating with the control knob (2) and being connected to the flame detector (6), and
   a lighting device (5) connected to the power control assembly (4),

and the method comprising the following steps:
when a user turns the control knob (2) until reaching the open position,
the sparker (7) automatically ignites the burner (3),
the flame detector (6) detects flame in the burner (3) as long as there is flame, and
when the user turns the control knob (2) until the desired power is achieved in the burner (3),
the lighting device (5) switches on according to a gas quantity passing to the burner (3) only as long as the flame detector (6) is detecting flame.

Clause 13. Method according to clause 12, wherein the lighting system (100) is connected to the ignitor (8) to be energized, the lighting system (100) also comprising a switch (12) connected to the flame detector (6) so that while the flame detector (6) is detecting flame in the burner (3) the switch (12) allows to connect the lighting system (100) to ground and thus an electric circuit (13; 13′) formed therein is closed.

Clause 14. Method according to clause 13, wherein the switch (12) is a transistor, the base of the transistor being connected to the flame detector (6), the collector of the transistor to the power control assembly (4) and the emitter of the transistor to ground.

Clause 15. Method according to clause 14, wherein the power control assembly (4) comprises a printed circuit board (9) comprising a plurality of tracks (9.1, 9.2, 9.3, 9.4) wherein some of said tracks (9.1, 9.2, 9.3, 9.4) are connected to the lighting device (5), the power control assembly (4) further comprises a rotary connector (11) which rotates in solidarity with the control knob (2), the rotary connector (11) comprising a plurality of protruding tabs (11.1) connected with each other, so that with the rotation of the control knob (2) the protruding tabs (11.1) of the rotary connector (11) contact with one or more tracks (9.1, 9.2, 9.3, 9.4) of the printed circuit board (9) depending on the angular position of the control knob (2) switching on the lighting device (5) if the flame of the burner (3) is on.

Clause 16. Method according to clause 15, wherein the lighting device (5) comprises a plurality of LEDs (5.1), the number of lit LEDs (5.1) being indicative of the quantity of gas passing to the burner (3).

Clause 17. Method according to clause 16, wherein the printed circuit board (9) comprises a flame track (9.2) connected to the flame detector (6) through the switch (12), a power track (9.3) connected to the ignitor (8), a sparker track (9.4) connected to the sparker (7) and a plurality of main tracks (9.1) connected to said flame track (9.2), each LED of the lighting device (5) being connected to a different main track (9.1), the electronic circuit (13; 13′) generated therein being closed when flame is detected in the burner (3) and the LED (5.1) associated to a respective main track (9.1) is lit if a protruding tab (11.1) or the rotary connector (11) is contacting to said respective main track (9.1).

Clause 18. Method according to clause 17, wherein each of the main track (9.1) finishes in a different angular position related to a rotation axis (10) of the control knob (2), so that when a main track (9.1) is not contacted by a protruding tab (11.1) of the rotary connector (11) the LED (5.1) associated to this main track (5) is not lit.

Clause 19. Method according to clause 17 or 18, wherein being the control knob (2) in the open position one protruding tab (11.1) of the rotary connector (11) contacts with the power track (9.3) of the printed circuit board (9) independently of the angular position of the control knob (2) and the rest of the protruding tabs (11.1) contacts with one or more main tracks (9.1) and/or with the sparker track (9.4) of the printed circuit board (9) depending on the angular position of the rotary connector (11).

Clause 20. Method according to any of clauses 17 to 19, wherein the open position of the control knob (2) further comprises an ignition position (2.2) for igniting the burner (3) so that when positioning the control knob (2) in said ignition position (2.2) a respective protruding tab (11.1) of the rotary connector (11) contacts with the sparker track (9.4) allowing the sparker (7) to ignite the burner (3) only in this angular position of the control knob (2).

Clause 21. Method according to any of clauses 17 to 19, wherein, being the control knob (2) in the open position, one protruding tab (11.1) of the rotary connector (11) contacts with the sparker track (9.4) independently of the angular position of the control knob (2) so that the sparker (7) is able to ignite the burner (3) in any of the operable positions (2.1) of the control knob (2).

Clause 22. Method according to any of clauses 17 to 21, wherein at least one of the main tracks (9.1) is in electrical contact to the sparker track (9.4) or to the power track (9.3).

Clause 23. Method according to any of clauses 18 to 22, wherein the protruding tabs (11.1) of the rotary connector (11) are protruding from a circular base (11.2) and are disposed in parallel, the free end of each of the protruding tab (11.1) defining a contact end (11.11) which is able to contact with a track (9.1, 9.2, 9.3, 9.4) of the printed circuit board (9), the contact ends (11.11) of all of the protruding tabs (11.1) being disposed in an offset parallel radial direction, so that in use only the contact ends (11.11) of the rotary connector (11) contacts the printed circuit board (9).

Clause 24. Method according to clauses 23, wherein when the control knob (2) is in the closed position the relative position between the rotary connector (11) and the printed circuit board (9) is such that the contact ends (11.11) of the rotary connector (11) are advanced an angle (a) with respect to a vertical axis (21) passing through the center of the rotation axis (10).

Clause 25. Method according to clauses 24, wherein when the control knob (2) is rotated 0° with respect to the vertical axis (21) the control knob (2) is in the closed position.

Clause 26. Method according to clause 24, wherein when the control knob (2) is rotated 90° counter clockwise with respect to the vertical axis (21) the control knob (2) is positioned in an operable position (2.1) where the gas quantity passing to the burner (3) is maximum, so that all LEDs (5.1) of the lighting device (5) are lit as long as the detector flame (6) is detecting flame in the corresponding burner (3).

Clause 27. Method according to clause 24, wherein when the control knob (2) is rotated 270° counter clockwise with respect to the vertical axis (21) the control knob (2) is positioned in an operable position (2.1) where the gas quantity passing to the burner (3) is minimum, so that only one LED (5.1) of the lighting device (5) is lit as long as the detector flame (6) is detecting flame in the corresponding burner (3).

Clause 28. Method according to clause 26 or 27, wherein the lighting device (5) comprises as many LEDs (5.1) as the number of defined operable positions (2.1) and wherein any other operable position (2.1) of the control knob (2) is positioned between 90° and 270° counter clockwise with respect to the vertical axis (21), decreasing the number of lit LEDs (5.1) as the control knob (2) rotates counter clockwise towards the next defined operable position (2.1).

Clause 29. Method according to any of clauses 25 to 28, wherein if the flame is extinguished unintentionally the sparker (7) of the ignitor (8) will automatically ignite the burner (3) again independently of the operable position (2.1) in which the control knob (2) is positioned.

Clause 30. Method according to any of clauses 25 to 28, wherein the open position of the control knob (2) further comprises an ignition position (2.2) for igniting the burner (3), disposed between 0° and 90° counter clockwise, so that the burner (3) only will ignite when the control knob (2) is positioned in said ignition position (2.2), the gas quantity passing to the burner (3) is maximum in said ignition position (2.2), so that when the detector flame (6) detects flame in the corresponding burner (3) all LEDs (5.1) of the lighting device (5) will be lit.

Clause 31. Method according to clause 30, wherein if the flame is extinguished unintentionally, being the control knob (2) in any of the operable positions (2.1), the control knob (2) must be positioned again in the ignition position (2.2) for igniting the burner (3) again.

What is claimed is:

1. A gas cooking appliance comprising:
a burner;
a flame detector for detecting a flame of the burner;
a gas valve configured to control gas flow to the burner;
a control knob operatively connected to the gas valve and rotatable to control the gas flow to the burner, the control knob being rotatable about a rotation axis between a closed position where no gas flow is allowed to pass to the burner and an open position where gas flow is allowed to pass to the burner, the open position comprising a plurality of operable positions wherein each operable position is related to a quantity of gas passing to the burner; and
a lighting system including a power control assembly electrically coupled to a lighting device and the flame detector, the control knob being operatively coupled to the power control assembly, the lighting system configured to cause an illumination of the lighting device to alter upon the control knob transitioning between the plurality of operable positions, the lighting system configured to cause the illumination of the lighting device only upon the flame detector detecting the flame of the burner.

2. The gas cooking appliance according to claim 1, wherein the flame detector is comprised in an ignitor, the lighting system configured to be energized by an ignitor.

3. The gas cooking appliance according to claim 2, wherein the lighting system also comprises a switch, the switch being configured to connect the lighting system to ground upon the flame detector detecting the flame in the burner.

4. The gas cooking appliance according to claim 3, wherein the switch is a transistor, a base of the transistor being connected to the flame detector, a collector of the transistor being connected to the power control assembly and the emitter of the transistor being connected to ground.

5. The gas cooking appliance according to claim 1 wherein the lighting device comprises a plurality of light emitting diodes, the illumination of the lighting device being altered by varying the number of light emitting diodes that are lit, the lighting system being configured such that as the control knob is rotated to increase the quantity of gas to the burner, the number of light emitting diodes that are lit increases.

6. The gas cooking appliance according to claim 2, wherein the power control assembly comprises a printed circuit board that includes a plurality of electrically conductive tracks, at least some of plurality of electrically conductive tracks being connected to the lighting device, the power control assembly further comprising a rotary connector that rotates in unison with the control knob, the rotary connector including a plurality of protruding tabs that are electrically connected to one another with each of the plurality of protruding tabs configured to contact with one or more of the plurality of electrically conductive tracks, the number of the plurality of protruding tabs contacting the plurality of electrically conductive tracks depending on an angular position of the rotary connector.

7. The gas cooking appliance according to claim 6, wherein the plurality of protruding tabs protrude from a base of the rotary connector and are disposed in parallel with respect to one another, a free end of each of the plurality of protruding tab defining a contact ending that is configured to contact with a respective one of the plurality of tracks of the printed circuit board, the contact endings being radially and angularly offset from one another, in use only the contact endings of the plurality of protruding tabs contact the printed circuit board.

8. The gas cooking appliance according to claim 6 wherein the lighting device comprises a plurality of light emitting diodes, the illumination of the lighting device being altered by varying the number of light emitting diodes that are lit, the lighting system being configured such that as the control knob is rotated to increase the quantity of gas to the burner, the number of light emitting diodes that are lit increases.

9. The gas cooking appliance according to claim 8, wherein the plurality of electrically conductive tracks includes a flame track electrically connected to the flame detector through a switch, a power track electrically connected to the ignitor, a sparker track connected to a spark generator comprised in the ignitor, and a plurality of main tracks electrically connected to the flame track, each of the plurality of light emitting diodes of the lighting device being connected to a different one of the plurality of main tracks, the switch being configured to connect to ground upon the flame detector detecting the flame in the burner in order to close an electrical circuit between the igniter and at least one of the plurality of light emitting diodes.

10. The gas cooking appliance according to claim 9, wherein one of the plurality of protruding tabs is configured to contact with the power track and a remainder of the plurality of protruding tabs being configured to contact with the plurality of main tracks and/or with the sparker track of the printed circuit board depending on the angular position of the rotary connector.

11. The gas cooking appliance according to claim 9, wherein at least one of the plurality of main tracks is electrically connected to the sparker track or to the power track.

12. The gas cooking appliance according to claim 8, wherein each of the plurality of main tracks terminates at a different angular position in reference to a rotation axis of the control knob, such that upon a first of the plurality of main tracks not being contacted by one of the plurality of protruding tabs, a light emitting diode associated with the first of the plurality of main tracks is not lit.

13. The gas cooking appliance according to claim 9, wherein when the control knob is in the open position one of the plurality of protruding tabs of the rotary connector contacts with the power track of the printed circuit board independently of an angular position of the control knob.

14. The gas cooking appliance according to claim 9, wherein the open position of the control knob includes an ignition position for igniting the flame in the burner, only when the control knob is in the ignition position a respective one of the plurality of protruding tabs of the rotary connector contacts with the sparker track to cause the spark generator to ignite the flame in the burner.

15. The gas cooking appliance according to claim 9, wherein when the control knob is in the open position one of the plurality of protruding tabs of the rotary connector contacts with the sparker track independently of an angular position of the control knob so that the sparker is able to ignite the flame in the burner in any of the plurality of operable positions of the control knob.

16. The cooking appliance according to claim 8, wherein when the control knob is rotated away from the closed position, the plurality of protruding tabs of the rotary connector advance at an angle with respect to a vertical axis passing through the rotation axis.

17. The cooking appliance according to claim 16, wherein the control knob and gas valve are configured such that when the control knob is rotated 0° with respect to the vertical axis, the control knob is in the closed position.

18. The cooking appliance according to claim 16, wherein the control knob and gas valve are configured such that when the control knob is rotated 90° counter-clockwise with respect to the vertical axis, the control knob is positioned in one of the plurality of operable positions corresponding to a maximum gas quantity passing to the burner, the lighting system being configured to energize all of the plurality of light emitting diodes.

19. The cooking appliance according to claim 16, wherein the control knob and gas valve are configured such that when the control knob is rotated 270° counter-clockwise with respect to the vertical axis, the control knob is positioned in one of the plurality of operable positions corresponding to a minimum gas quantity passing to the gas burner, the lighting system being configured to energize only one of the plurality of light emitting diodes.

20. The cooking appliance according to claim 1, further comprising an ignitor that includes a spark generator, the ignitor configured such that upon the flame detector detecting no flame of the burner, the spark generator automatically energizes to attempt to ignite the flame of the burner independently of the operable position in which the control knob is positioned.

21. The cooking appliance according to claim 14, further comprising an ignitor that includes a spark generator, the ignitor configured such that upon the flame detector detecting no flame of the burner, the spark generator energizes to attempt to ignite the flame of the burner when the control knob is positioned in the ignition position.
